(19) United States
(12) Patent Application Publication
(10) Pub. No.: US 2013/0218647 A1
(43) Pub. Date: Aug. 22, 2013

(54) SYSTEMS AND METHODS FOR BOOKING TRANSPORT

(71) Applicants: Amin KROLL, Newington (AU); Ayman AHMAD, (US)

(72) Inventors: Amin KROLL, Newington (AU); Ayman AHMAD, (US)

(73) Assignee: CAR PILOTS PTY LTD, Rhodes (AU)

(21) Appl. No.: 13/483,708

(22) Filed: May 30, 2012

(30) Foreign Application Priority Data
Feb. 21, 2012 (AU) 2012900645

(51) Int. Cl. G07B 15/02

(52) U.S. Cl. 705/13

(57) ABSTRACT

Systems and methods for booking transport are described including a method including the steps of: receiving job information including pick-up location information and destination location information from a user; calculating the cost of the job based on the location information; and notifying the user of the calculated cost.

This application claims priority from Australian Application No. 2012 900645 filed Feb. 21, 2012.

### TECHNICAL FIELD

The present invention relates to methods and systems for booking transport. The invention has particular application to booking transport such as hire cars and limousines but is not limited to that application.

### SUMMARY OF THE INVENTION

In a first aspect the present invention provides a method of booking transport including the steps of: receiving job information including pick-up location information and destination location information from a user; calculating the cost of the job based on the location information; and notifying the user of the calculated cost.

The pick-up location information may be derived automatically from a positioning system such as a GPS receiver.

In a second aspect the present invention provides a system for booking transport including: receiving means for receiving job information including pick-up location information and destination location information from a user; calculating means for calculating the cost of the job based on the location information; and notifying means for notifying the user of the calculated cost.

In a third aspect the present invention provides a method of booking transport including the steps of: notifying transport providers of available jobs and providing them with job information including pick-up location information and destination location information; receiving bid information from the transport providers indicating their price for undertaking the job; and assigning the job to one of the providers based on the bid information.

In a fourth aspect the present invention provides a system for booking transport including: notifying means for notifying transport providers of available jobs and providing them with job information including pick-up location information and destination location information; receiving means for receiving bid information from the transport providers indicating their price for undertaking the job; and assigning the job to one of the providers based on the bid information.

In a fifth aspect the present invention provides a method of booking transport including the steps of: receiving job information including pick-up location information and destination location information from a user; assigning the job to a transport provider; and displaying the approximate current location of the transport provider on a display device of the user on an ongoing basis.

In a sixth aspect the present invention provides a system for booking transport including: receiving means for receiving job information including pick-up location information and destination location information from a user; assigning means for assigning the job to a transport provider; and display means for displaying the approximate current location of the transport provider on a display device of the user on an ongoing basis.

### BRIEF DESCRIPTION OF THE DRAWINGS

An embodiment of the present invention will now be described, by way of example only, with reference to the accompanying drawings, in which:

FIG. 1 is a schematic representation of a system according to the present invention;

FIGS. 2 to 4 illustrate user interfaces presented to users of the system of FIG. 1.

### DETAILED DESCRIPTION OF THE PREFERRED EMBODIMENT

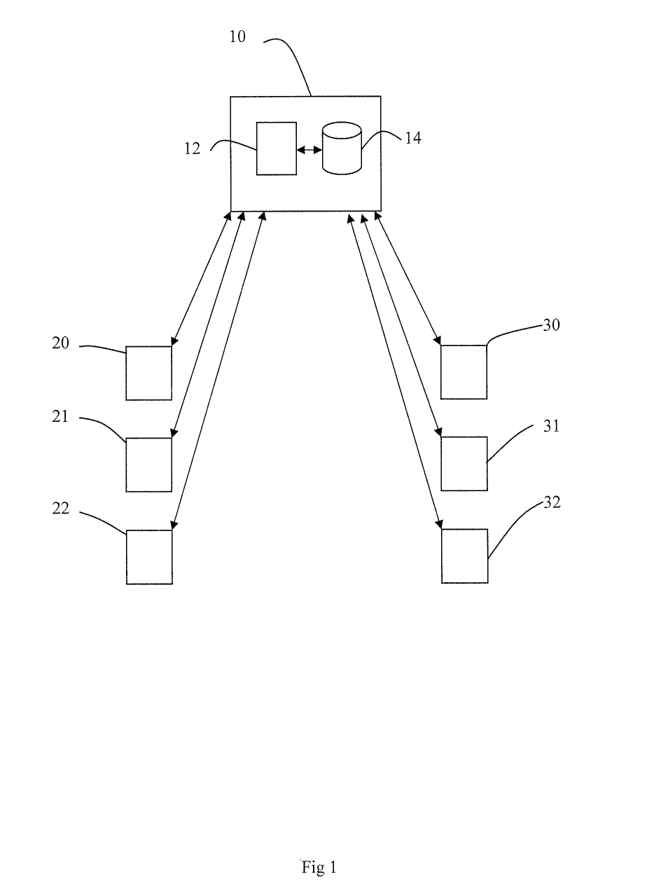

Referring to FIG. 1, a system 10 is shown for booking transport. The system will be described with reference to booking hire cars or limousines, although it is not limited to that application.

Users of the system are depicted as passengers 20, 21, 22. Providers of transport are depicted as hire car drivers 30, 31, 32. System 10 is hosted on an internet connected web server 12 with access to a database system 14. Passengers 20, 21, 22 and drivers 30, 31 32 interact with system 10 by way of software applications installed on their mobile phones which communicate by wireless internet with web server 12.

Operation of system 10 will be described with reference to the process of a passenger making a booking for a hire car.

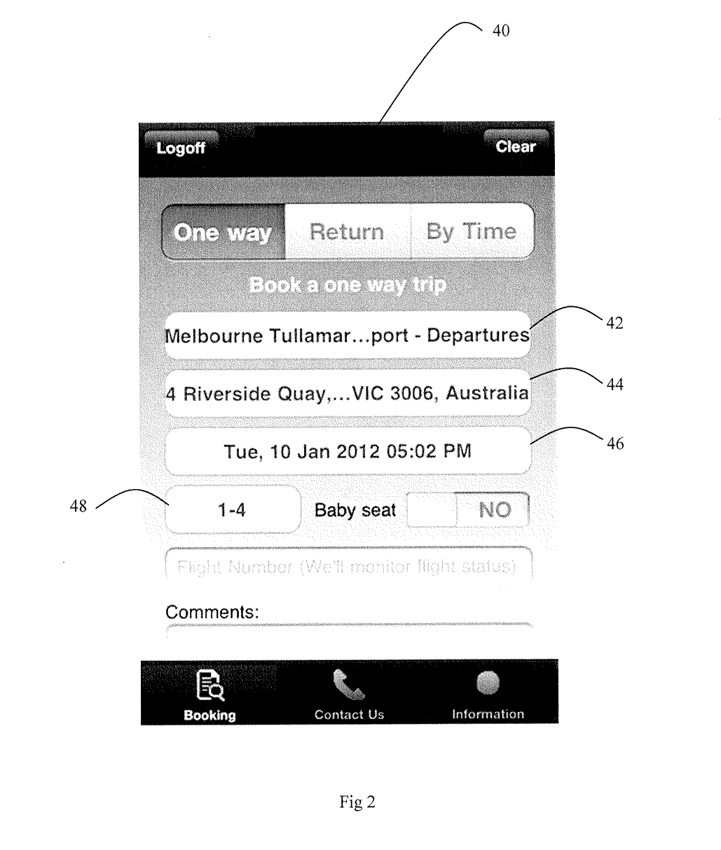

Passenger 20 wishes to book a hire car for a trip to the airport. Referring to FIG. 2, passenger opens their software application on their mobile phone and selects the booking interface 40. At that interface, the user inputs destination location information being their required destination address at input field 42 and pick-up location information being their required pick-up address at input field 44 along with their desired pick-up time at input field 46. There are also tabs at the top of the screen (one-way, return and by time) which represent trip modes. The user must select one of these modes.

Instead of entering a pick-up address, passenger may select an option whereby the software application uses GPS data made available by their mobile phone to automatically determine the current location of the passenger. In this version, the user instead confirms that the detected pick-up location is correct.

The passenger selects from available options of number of passengers travelling at box 48. The passenger may select other options such as type or class of vehicle required, requirements for a baby seat etc.

When the passenger has completed entering all relevant details on the booking interface, they select an option “submit”. The software application then sends job information to system 10 which includes details of the information entered or selected at the booking interface.

The job information is received and processed by system 10. System 10 analyses the pick-up and destination addresses to calculate the distance between the pick-up location and the destination location. The costs per kilometre or per hour depending upon the selected trip mode for various types of vehicles are looked up in database 14 along with details of any other adjustments such as public holiday surcharges, airport surcharges, flag-fall fees etc. System then calculates the cost of the job that the user has submitted for all suitable types of vehicles for the job and presents the user with a vehicle selection screen. Suitable vehicles are presented (based on the number of passengers) along with the corresponding calculated costs for the job.

The user then selects their preferred vehicle. They are then presented with a summary page which includes all relevant details of the job they are submitting. The user confirms these details and then is presented with a payment page. When payment has been successfully made, the job is processed by the system to allocate the job to a driver as will now be described.

During operation of the system 10, many passengers submit booking requests for various jobs. Drivers wishing to receive jobs from system 10 pre-register with the operator of the system to define various criteria such as the types of vehicle(s) they operate, and the region in which they operate.

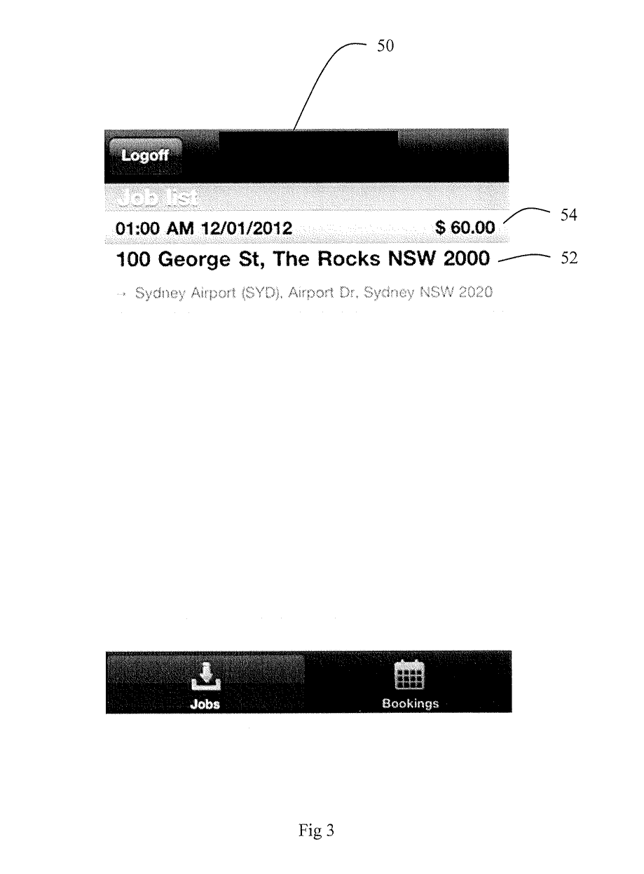

System 10 notifies drivers 30, 31, 32 of available jobs which match their previously defined criteria by way of a push notification to the software application on their mobile phone. Referring to FIG. 3, available job interface 50 is shown which displays a list of matching jobs 52 to a particular driver along with the calculated cost of the job. If a driver wishes to take on a job then they select that job on-screen.

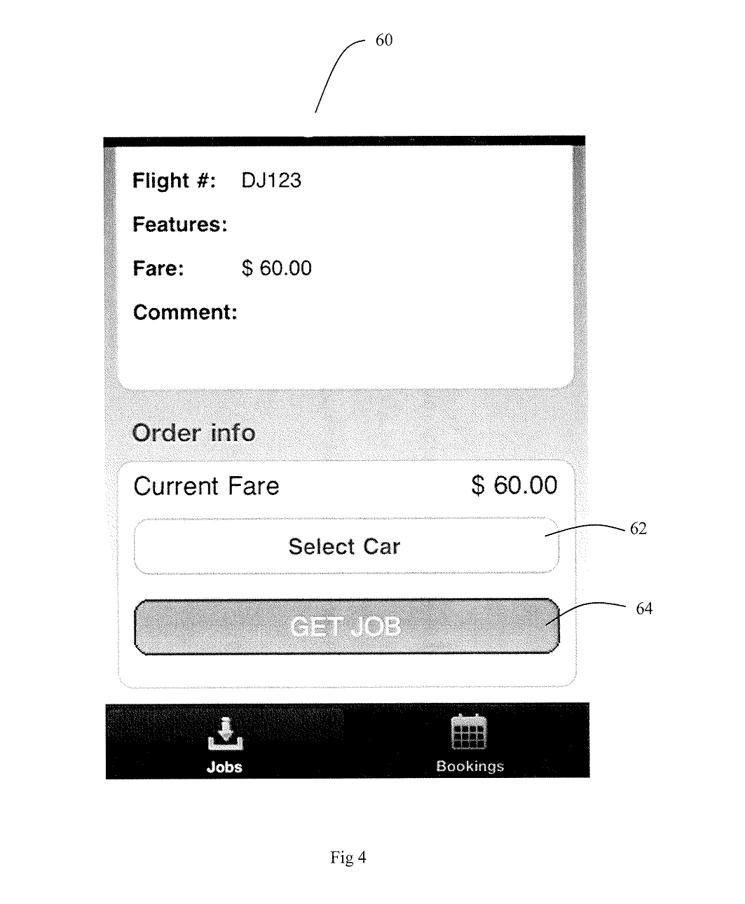

Referring to FIG. 4, when a driver selects a job they wish to take they are shown job confirmation interface 60. In the case that a driver has registered more than one vehicle, they select the vehicle they propose to use for the job using button 62. Driver confirms that they wish to take a job by using button 64 “Get Job”. This causes information to be sent to system 10 notifying that a particular driver has elected to take on a particular job. System then assigns that job to that driver and sends a confirmation message to the driver. At the same time, system sends a notification to the passenger who submitted the job request advising them that their job has been assigned to a driver.

The software used by drivers regularly transmits their current locations to system 10 by way of GPS data made available by their mobile phone. Shortly before the designated pick-up time, the user may elect to view the current location of their assigned driver on a map screen by selecting the appropriate option in their software application. System 10 regularly transmits the latest location information for their assigned driver to their device. An icon indicating the approximate current location of their assigned driver is overlayed on the map.

As previously mentioned, system 10 consists of an internet connected web server computer 12 which has access to a database system 14. Server computer runs an operating system running software written and configured to carry out the above described method. Features of system 10 are therefore embodied in a combination of hardware and software including:

Receiving means for receiving information from users of the system by way of internet, wireless internet or SMS messages.

Calculating means for calculating various variables used in the system such as cost and distance etc.

Notifying means for notifying users by way of push messaging over internet or SMS messaging or the like.

Assigning means for assigning jobs to particular drivers according to pre-defined rules and events.

Display means for displaying information to users is embodied in the display screens of their own personal computing device.

In a modified version of the method described above, drivers may make bids for jobs. Following selection of a job at job selection interface 50, the driver inputs a price at which he is willing to undertake that job and that price information is transmitted as a bid to system 10. After the job has been available for a particular period of time, or at a pre-determined period before the desired pick-up time, bidding closes. The system then assigns the job to the driver who made the lowest bid.

In some embodiments, a passenger may provide feedback by way of entering details into their software application regarding their experience of a particular driver. In some embodiments, the passenger may elect that they do not wish to engage a particular driver again. In this case, jobs for that passenger are not made available to that driver.

It can be seen that embodiments of the invention have at least one of the following advantages:

Passengers are advised of the exact price of the job they have submitted prior to the job being carried out

Passengers are able to view the approximate current location of the driver that has been assigned their job. This provides a passenger with peace of mind that they are going to be picked-up at their required time

By enabling drivers to bid for jobs, passengers can obtain services at a competitive price

In the system and method described above, transport was booked being hire cars or limousines. Similarly, the invention has application to other types of transport including buses, boat taxis, trains, motorbikes, boats, cruises, airplanes or helicopters.

In the system and method described above, users interacted with the system by way of software installed on their mobile phones. Similarly, other devices with an internet browser could be used such as tablet computers, webpads etc. Drivers may use dedicated hardware devices.

System 10 may include an application programming interface (API) to allow integration with one or more global distribution systems (GDS). These are interfaces used by travel agents or the like. This API thus allows travel agents to book vehicles or other transport natively through the GDS they operate.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A method of booking transport including the steps of:
receiving job information including pick-up location information and destination location information from a user;
calculating the cost of the job based on the location information; and
notifying the user of the calculated cost.

2. A method according to claim 1 wherein the pick-up location information is derived automatically from a positioning system such as a GPS receiver.

3. A system for booking transport including:
receiving means for receiving job information including pick-up location information and destination location information from a user;
calculating means for calculating the cost of the job based on the location information; and
notifying means for notifying the user of the calculated cost.

4. A system according to claim 3 wherein the pick-up location information is derived automatically from a positioning system such as a GPS receiver.

5. A method of booking transport including the steps of:
notifying transport providers of available jobs and providing them with job information including pick-up location information and destination location information;
receiving bid information from the transport providers indicating their price for undertaking the job; and
assigning the job to one of the providers based on the bid information.

6. A system for booking transport including:
notifying means for notifying transport providers of available jobs and providing them with job information including pick-up location information and destination location information;
receiving means for receiving bid information from the transport providers indicating their price for undertaking the job; and
assigning means for assigning the job to one of the providers based on the bid information.

7. A method of booking transport including the steps of:
receiving job information including pick-up location information and destination location information from a user;
assigning the job to a transport provider; and
displaying the approximate current location of the transport provider on a display device of the user on an ongoing basis.

8. A system for booking transport including:
receiving means for receiving job information including pick-up location information and destination location information from a user;
assigning means for assigning the job to a transport provider; and
display means for displaying the approximate current location of the transport provider on a display device of the user on an ongoing basis.
